(19) United States
(12) Patent Application Publication
(10) Pub. No.: US 2022/0154305 A1
(43) Pub. Date: May 19, 2022

(54) Hot Stamped Part and Method for Manufacturing the Same

(71) Applicants: Hyundai Motor Company, Seoul (KR); Kia Corporation, Seoul (KR)

(72) Inventors: Yeon Jung Hwang, Seoul (KR); Jae Ik Yoon, Incheon (KR); Chang Wook Lee, Anyang-si (KR)

(21) Appl. No.: 17/307,100

(22) Filed: May 4, 2021

(30) Foreign Application Priority Data
Nov. 13, 2020 (KR) 10-2020-0151949

(51) Int. Cl. C21D 9/48; B32B 15/01; C21D 6/00; C21D 1/673; C22C 38/38; C22C 38/32; C22C 38/02; C22C 38/00; B21D 22/02

(52) U.S. Cl. CPC C21D 9/48; C21D 2211/005; B32B 15/013; C21D 6/005; C21D 6/008; C21D 6/002; C21D 1/673; C22C 38/38; C22C 38/32; C22C 38/02; C22C 38/002; B21D 22/022; C21D 2211/008; C21D 2211/002; B32B 15/012

(57) ABSTRACT

Disclosed is a hot stamped part, which has improved toughness while maintaining high strength and high hardness, and a method for manufacturing the same. The hot stamped part is formed by performing hot stamping using an iron-based alloy, and includes a reinforced portion formed to have a martensite structure, a softened portion formed to have ferrite and bainite structures, and a transition portion formed between the reinforced portion and the softened portion. The reinforced portion, the transition portion and the softened portion are formed in the thickness direction of the hot stamped part.

### CROSS-REFERENCE TO RELATED APPLICATION

This application claims priority from Korean Patent Application No. 10-2020-0151949, filed on Nov. 13, 2020, in the Korean Intellectual Property Office, the disclosure of which is incorporated herein by reference in its entirety.

### FIELD

The present disclosure relates to a hot stamped part and a method for manufacturing the same, and more particularly to a hot stamped part, which has improved toughness while maintaining high strength and high hardness, and a method for manufacturing the same.

### BACKGROUND

In general, hot stamping is a method in which a plate is heated to a high temperature of 900° C. or higher and is then forming and cooling are simultaneously performed using a press in which cooling water flows so as to form a product and, because the product acquired by hot stamping may have a complicated shape and secure excellent dimensional precision and high strength, hot stamping is being applied as a method for manufacturing various parts for vehicles.

A part manufactured by hot stamping is transformed to have the full austenite structure when it is heat-treated at the A3 temperature or higher, and finally forms the martensite structure due to cooling during hot stamping. Therefore, the part manufactured by hot stamping has very high strength and high hardness, but has insufficient toughness and is thus cracked in a collision test.

Among parts applied to vehicles, in case of a center pillar reinforcement manufactured by hot stamping, when the center pillar reinforcement is cracked, it does not serve as a collision member any more, and thus does not protect passengers due to the increased intrusive volume thereof.

In order to compensate for the defect of the center pillar reinforcement manufactured by hot stamping, the strength of the lower end of the center pillar reinforcement in the length direction of a center pillar is decreased by local softening, or a steel plate having low strength is applied to the lower end of the center pillar reinforcement using the tailor welded blank (TWB) technology.

The above information disclosed in the Background section is only for enhancement of understanding of the background of the disclosure and should not be interpreted as conventional technology that is already known to those skilled in the art.

### SUMMARY

Therefore, the present disclosure has been made in view of the above problems, and it is an object of the present disclosure to provide a hot stamped part, which has improved toughness while maintaining high strength and high hardness so as to secure excellent bendability by controlling formation of microstructures in the thickness direction thereof, and a method for manufacturing the same.

In accordance with an aspect of the present disclosure, the above and other objects can be accomplished by the provision of a hot stamped part, formed by performing hot stamping using an iron-based alloy, the hot stamped part including a reinforced portion formed to have a martensite structure, a softened portion formed to have ferrite and bainite structures, and a transition portion formed between the reinforced portion and the softened portion, wherein the reinforced portion, the transition portion and the softened portion are formed in a thickness direction of the hot stamped part.

A ratio of a thickness of the softened portion to a total thickness of the hot stamped part may be equal to or less than 30%.

The transition potion may be formed to have the ferrite, bainite and martensite structures.

The iron-based alloy may include 0.19-0.25 wt % of C, 0.40 wt % or less of Si, 1.10-1.60 wt % of Mn, 0.030 wt % or less of P, 0.015 wt % or less of S, 0.10-0.60 wt % of Cr, 0.0008-0.0050 wt % of B, the balance of Fe, and inevitable impurities.

A tensile strength of the hot stamped part may be equal to or greater than 1300 MPa.

A bending angle of the hot stamped part may be equal to or greater than 90°.

A plating layer formed of an Al—Si-based alloy or a Zn-based alloy may be further formed on each of surfaces of the reinforced portion and the softened portion.

In accordance with another aspect of the present disclosure, there is provided a method for manufacturing a hot stamped part, the method including preparing a plate-type base metal using an iron-based alloy, heating the prepared base metal, forming a product by inserting the heated base metal between a first die and a second die and then pressing the base metal, and cooling the product formed between the first die and the second die while differently maintaining a cooling speed of one surface of the product configured to come into contact with the first die and a cooling speed of a remaining surface of the product configured to come into contact with the second die.

In the forming the product, the first die may be a heated die and the second die is a cooled die, and the heated base metal may be placed on the first die.

In the forming the product, a cavity having a recessed shape may be formed in the first die, a protrusion having a projecting shape may be formed on the second die so as to be inserted into the cavity, and a heated heating pad may be disposed in the cavity of the first die, and, in the forming the product, when the heated base metal is placed on the first die, the heated base metal may be placed on an upper surface of the first die and an upper surface of the heating pad.

In the forming the product, while the second die comes close to the first die and thus presses the heated base metal placed on the first die, the heating pad disposed in the cavity of the first die may be inserted into the first die by pressing force of the second die, and thus, a space configured such that the heated base metal is formed into the product may be secured.

In the cooling the product, a softened portion configured to have ferrite and bainite structures may be formed from the surface of the product configured to come into contact with the first die, and a reinforced portion configured to have a martensite structure may be formed from the remaining surface of the product configured to come into contact with the second die.

In the cooling the product, the softened portion may be formed such that a ratio of a thickness of the softened portion to a total thickness of the product is equal to or less than 30%.

In the cooling the product, the cooling speed of the surface of the product configured to come into contact with the first die may be 3-5° C./s in a temperature section of 850-500° C., and the cooling speed of the remaining surface of the product configured to come into contact with the second die may be equal to or higher than 27° C./s in a temperature section of 850-250° C.

In the forming the product, the first die may be heated to a temperature range of 300-450° C.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a cross-sectional view of a hot stamped part according to one embodiment of the present disclosure, in the thickness direction thereof;

FIG. 2A illustrates a first step in a method for manufacturing a hot stamped part according to one embodiment of the present disclosure;

FIG. 2B illustrates a second step in the method of FIG. 2A for manufacturing a hot stamped part according to one embodiment of the present disclosure;

FIG. 2C illustrates a hot stamped part resulting from the methods of FIGS. 2A-2B according to one embodiment of the present disclosure; and

FIG. 3 is a graph showing results of a bending test of an example and a comparative example of the present disclosure.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to the exemplary embodiments. Wherever possible, the same reference numbers will be used throughout the drawings to refer to the same or like parts.

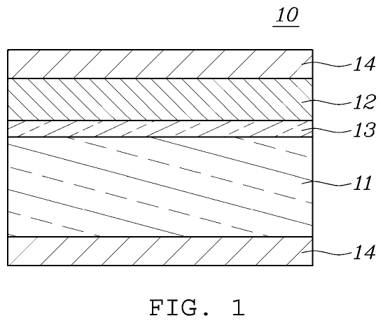

FIG. 1 is a cross-sectional view of a hot stamped part according to one embodiment of the present disclosure, in the thickness direction thereof.

As shown in FIG. 1, the hot stamped part according to one embodiment of the present disclosure is a part formed by performing hot stamping using an iron-based alloy, and 22MnB5, which is generally used as an alloy for hot stamping, is applied as the iron-based alloy. For example, the iron-based alloy includes 0.19-0.25 wt % of C, 0.40 wt % or less of Si, 1.10-1.60 wt % of Mn, 0.030 wt % or less of P, 0.015 wt % or less of S, 0.10-0.60 wt % of Cr, 0.0008-0.0050 wt % of B, the balance of Fe, and inevitable impurities.

The hot stamped part according to one embodiment of the present disclosure using the iron-based alloy, which is generally used as an alloy for hot stamping, is a part which has improved toughness while maintaining high strength and high hardness so as to secure excellent bendability by forming different microstructures in the thickness direction thereof, in contrast to a conventional hot stamped part which is formed to have the full martensite structure and thus has high strength and high hardness but has low toughness.

For example, a hot stamped part 10 according to one embodiment of the present disclosure includes a reinforced portion 11 configured to be formed of the martensite structure after hot stamping, a softened portion 12 configured to be formed of the ferrite and bainite structures, and a transition portion 13 formed between the reinforced portion 11 and the softened portion 12. Here, the reinforced portion 11, the transition portion 13 and the softened portion 12 are sequentially formed in the thickness direction of the hot stamped part 10.

The reinforced portion 11 is a region configured to form the hot stamped part 10, and is formed by transforming a base metal, which is formed of the ferrite and perlite structures at room temperature, to the full austenite structure by heating the base metal to the A3 temperature or higher, and then transforming the full austenite structure to the full martensite structure by rapidly cooling the full austenite structure to room temperature. Thereby, the reinforced portion 11 serves to maintain stiffness required by a collision member when the hot stamped part is applied to the collision member.

The softened portion 12 is a region configured to improve bendability of the hot stamped part 10, and is formed by transforming a base metal, which is formed of the ferrite and perlite structures at room temperature, to the full austenite structure by heating the base metal to the A3 temperature or higher, and then transforming the full austenite structure to the ferrite and bainite structures by slowly cooling the full austenite structure to room temperature. Thereby, the softened portion 12 serves to improve bendability required by a collision member when the hot stamped part is applied to the collision member.

During the process for cooling the hot stamped part 10, the reinforced portion 11 is formed from one surface of the hot stamped part 10, the softened portion 12 is formed from the other surface of the hot stamped part 10, and thereby, the transition portion 13, in which all of the ferrite, bainite and martensite structures are formed, is formed between the reinforced portion 11 and the softened portion 12.

The transition portion 13 serves as a buffer between the reinforced portion 11 configured to maintain stiffness of the hot stamped part 10 and the softened portion 12 configured to improve bendability of the hot stamped part 10.

Particularly, the softened portion 12 may be formed to have a thickness which is equal to or less than 30% of the total thickness of the hot stamped part 10. When the thickness of the softened portion 12 exceeds 30% of the total thickness of the hot stamped part 10, the toughness of the hot stamped part 10 is increased and thus the bendability thereof is improved, whereas the tensile strength of the hot stamped part 10 is greatly reduced and thus the hot stamped part 10 does not serve as a collision member.

Further, in order to apply the hot stamped part 10 according to one embodiment of the present disclosure to a collision member, such as a center pillar which is a part for vehicles, the hot stamped part 10 may have a tensile strength of 1300 MPa or more and a bending angle of 90° or more.

The hot stamped part 10 according to one embodiment of the present disclosure may further include a plating layer 14 which is formed of an Al—Si-based alloy or a Zn-based alloy so as to cover each of the surfaces of the reinforced portion 11 and the softened portion 12. As such, the plating layers 14 are formed on the outermost surfaces of the hot stamped part 10, thereby improving corrosion resistance of the surfaces of the hot stamped part 10. Of course, the plating layers 14 formed on the surfaces of the reinforced portion 11 and the softened portion 12 are not limited to an Al—Si-based alloy or a Zn-based alloy, and plating layers which are formed of various materials so as to protect the surfaces of the hot stamped part 10 may be formed depending on specifications applied to the hot stamped part 10.

Next, a method for manufacturing a hot stamped part according to one embodiment of the present disclosure and a die set for hot stamping used to manufacture the hot stamped part will be described.

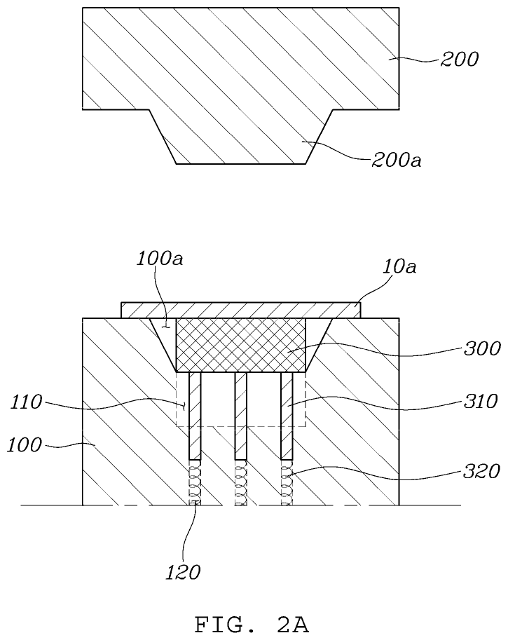

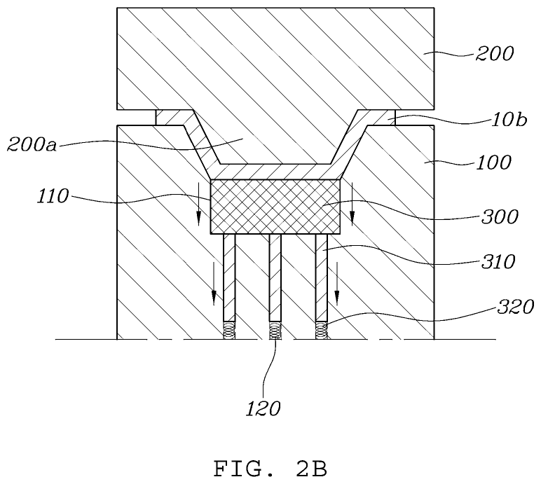

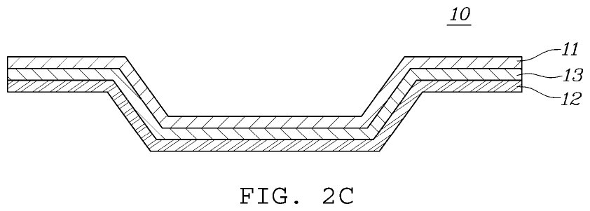

FIGS. 2A to 2C are views illustrating the method for manufacturing the hot stamped part according to one embodiment of the present disclosure.

First, the die set to which the method for manufacturing the hot stamped part according to one embodiment of the present disclosure is applied will be described.

As shown in FIGS. 2A to 2C, the die set for hot stamping is an apparatus which produces a hot stamped part by inserting a heated base metal 10a between a first die 100 and a second die 200 and then pressing the heated base metal 10a so as to form a product, the first die 100 is a heated die, and the second die 200 is a cooled die. Here, the heated die means a die which is directly or indirectly heated, and the cooled die means a die which is directly or indirectly cooled. For example, the first die 100 may be heated to the temperature range of a desired level by allowing a heated fluid to flow thereinto, and the second die 200 may be cooled to the temperature range of a desired level by allowing a cooled fluid to flow thereinto.

Further, in this embodiment, in order to prevent the heated base metal 10a from being rapidly cooled when the heated base metal 10a is placed between the first die 100 and the second die 200, the heated base metal 10a may be placed on the first die 100. For this purpose, in this embodiment, the first die 100 may be disposed as a lower die, and the second die 200 may be disposed as an upper die.

Further, a cavity 100a having a recessed shape is formed in the first die 100, and a protrusion 200a having a projecting shape, which is inserted into the cavity 100a, is formed on the second die 200.

Particularly, in this embodiment, a heated heating pad 300 may further disposed in the cavity 100a of the first die 100. In order to prevent one surface of the heated base metal 10a from being exposed to the cavity 100a and being thus cooled when the surface of the heated base metal 10a is placed on the upper surface of the first die 100, the heated heating pad 300 is disposed in the cavity 100a so that the surface of the heated base metal 10a comes into contact with the upper surface of the first die 100 and the upper surface of the heating pad 300. Thereby, rapid cooling of one surface of the heated base metal 10a may be suppressed.

A recess 110, into which the heating pad 300 is inserted, is formed in the first die 100 so as to secure a space in which the base metal 10a is formed into a product while removing the heating pad 300 from the cavity 100a of the first die 100 during pressing. Here, the recess 110 having a shape corresponding to the shape of the heating pad 300 is formed under the cavity 100a. Therefore, while the second die 200 is pressed from above the first die 100, the heating pad 300 is inserted into the recess 110 by the pressing force of the second die 200. In this case, the upper surface of the heating pad 300 is used as the lower surface of the cavity 100a formed in the first die 100.

One or more guide grooves 120, which guide movement of the heating pad 300, are formed under the recess 110, and guide bars 310, which are inserted into the guide grooves 120 so as to be guided, are formed on the lower surface of the heating pad 300. Thereby, movement of the heating pad 300 is guided when the heating pad 300 is moved upwards and downwards. Further, elastic members 320, which provide restoring force to withdraw the heating pad 300 towards the cavity 100a, are installed in the guide grooves 120. For example, coil springs may be used as the elastic members 320. Therefore, while the second die 200 is pressed onto the first die 100, the heating pad 300 is moved downwards and thus inserted into the recess 110 and, when the pressing force of the second die 200 is released, the heating pad 300 is withdrawn towards the cavity 100a by the restoring force of the elastic members 320. Further, while the second die 200 is pressed onto the first die 100, the heating pad 300 is moved downwards in the state in which the heating pad 300 is pressed against one surface of the heated base metal 10a by the elastic members 320, thereby being capable of delaying cooling of the heated base metal 10a.

Next, a method for manufacturing a hot stamped part using the above-described hot stamping apparatus will be described.

A method for manufacturing a hot stamped part according to one embodiment of the present disclosure includes preparing a plate-type base metal 10a using an iron-based alloy, heating the prepared base metal 10a, forming a product 10b by inserting the heated base metal 10a between the first die 100 and the second die 200 and then pressing the base metal 10a, and cooling the product 10b formed between the first die 100 and the second die 200 while differently maintaining a cooling speed of one surface of the product 10b which comes into contact with the first die 100 and a cooling speed of the other surface of the product 10b which comes into contact with the second die 200.

In the preparation of the base metal 10a, 22MnB5, which is generally used as an alloy for hot stamping, is applied into a plate type.

Here, microstructures of the base metal 10a include the ferrite and bainite structures.

In the heating of the base metal 10a, the microstructures of the base metal 10a are transformed into the full austenite structure by heating the prepared base metal 10a to the A3 temperature or higher. For example, in the heating of the base metal 10a, the base metal 10a is heated to a temperature of 900° C. or higher.

In the formation of the product 10b, the product 10b is formed by inserting the heated base metal 10a between the first die 100 and the second die 200 and then pressing the base metal 10a. First, the heated base metal 10a is placed on the upper surface of the heated first die 100. Here, one surface of the heated base metal 10a is placed on the upper surface of the first die 100 and the upper surface of the heating pad 300.

In this state, the second die 200 is moved downwards so as to press the heated base metal 10a. Then, while the second die 200 comes close to the first die 100 and thus presses the heated base metal 10a placed on the first die 100, the heating pad 300 disposed in the cavity 100a of the first die 100 is inserted into the recess 110 of the first die 100 by the pressing force of the second die 200, and thus, the space in which the heated base metal 10a is formed into the product 10b is secured. Here, the state, in which the heating pad 300 is pressed against one surface of the heated base metal 10a, is maintained by the elastic members 320.

Subsequent to the formation of the product 10b, the product 10b is cooled.

In the cooling of the product 10b, the product 10b formed between the first die 100 and the second die 200 is cooled while differently maintaining the cooling speed of one surface of the product 10b which comes into contact with the first die 100 and the cooling speed of the other surface of the product 10b which comes into contact with the second die 200.

In more detail, one surface of the product 10b is slowly cooled by the first die 100, and the other surface of the product 10b is rapidly cooled by the second die 200.

Thereby, one surface of the product 10b is slowly cooled to room temperature and thus transformed into the ferrite and bainite structures, thereby forming a softened portion 12. Further, the other surface of the product 10b is rapidly cooled to room temperature and thus transformed into the full martensite structure, thereby forming a reinforced portion 11. Further, the transition portion 13, in which all of the ferrite, bainite and martensite structures are formed, is formed between the reinforced portion 11 and the softened portion 12.

In the cooling of the product 10b, the cooling speed of the product 10b due to the first die 100 is adjusted so that the thickness of the softened portion 12 has a ratio of 30% or less to the total thickness of the product 10b.

For example, the cooling speed of the surface of the product 10b, which comes into contact with the first die 100, is 3-5° C./s in a temperature section of 850-500° C., and the cooling speed of the other surface of the product 10b, which comes into contact with the second die 200, is equal to or higher than 27° C./s in a temperature section of 850-250° C.

For this purpose, in the formation of the product 10b, the first die 100 is heated to a temperature range of 300-450° C.

Hereinafter, the present disclosure will be described through examples and a comparative example.

A plate formed of 22MnB5 as an alloy was heated to a temperature of 950° C. so as to have the full austenite structure, and then, forming and cooling of the plate were performed using the hot stamping apparatus according to the present disclosure.

Here, the heating temperature of the first die was changed, as set forth in Table 1 below, and the ratios of softened portions formed thereby were measured, as set forth in Table 1 below.

TABLE 1

| Heating temperature of | Ratio of thickness of |
|---|---|
| first die (° C.) | softened portion (%) |
| 300 | 0 |
| 400 | 6 |
| 425 | 12 |
| 450 | 21 |
| 475 | 34 |
| 500 | 43 |
| 600 | 68 |

As stated in Table 1, it may be confirmed that, when the heating temperature of the first die is maintained within the range of 300-450° C., the ratio of the thickness of the softened portion to the total thickness of the product is 30% or less.

Next, the tensile strengths of the products acquired by the above test were measured, and results of the measurement of the tensile strengths are set forth in Table 2 below.

TABLE 2

| Ratio of thickness of | Tensile |
|---|---|
| softened portion (%) | strength (MPa) |
| 6 | 1487 |
| 12 | 1440 |
| 21 | 1379 |
| 34 | 1292 |
| 43 | 1212 |

As stated in Table 2, it may be confirmed that, when the ratio of the thickness of the softened portion to the total thickness of the product is maintained in the range of 30% or less, the tensile strength of the product is maintained at 1300 MPa or more.

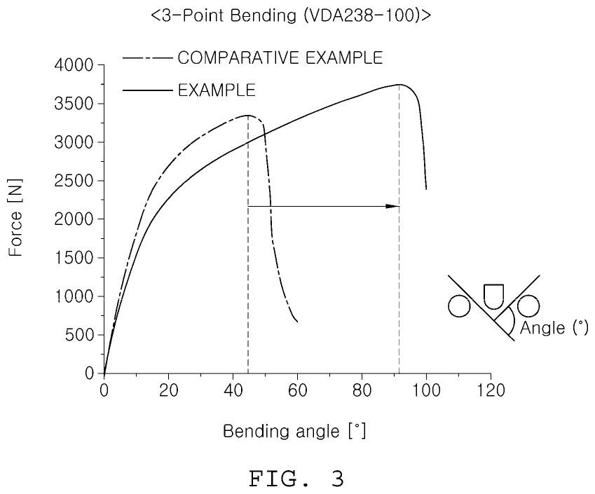

Thereafter, a 3-point bending test, i.e., the VDA238-100 test, was conducted on the comparative example, in which a conventional general hot stamped part, i.e., a hot stamped part having the full martensite structure, is formed, and the example, in which a hot stamped part according to the present disclosure, i.e., a hot stamped part having a ratio of the thickness of a softened portion thereof, which is 21%, is formed, and results of the test are shown in FIG. 3.

As shown in FIG. 3, it may be confirmed that the hot stamped part according to the example of the present disclosure maintains a bending angle of 90° or more.

As is apparent from the above description, in a hot stamped part and a method for manufacturing the same according to the present disclosure, the martensite structure may be formed on one surface of a product in the thickness direction thereof and the ferrite and bainite structures may be formed on the other surface of the product by differently controlling the cooling speeds of both surfaces of the product during hot stamping.

Thereby, the hot stamped part, which has improved toughness while maintaining high strength and high hardness so as to secure excellent bendability, may be manufactured.

Therefore, a collision member having excellent performance, such as a center pillar for vehicles, may be manufactured by a comparatively simple process.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A hot stamped part, formed by performing hot stamping using an iron-based alloy, the hot stamped part comprising:
a reinforced portion formed to have a martensite structure;
a softened portion formed to have ferrite and bainite structures; and
a transition portion formed between the reinforced portion and the softened portion,
wherein the reinforced portion, the transition portion and the softened portion are formed in a thickness direction of the hot stamped part.

2. The hot stamped part according to claim 1, wherein a ratio of a thickness of the softened portion to a total thickness of the hot stamped part is equal to or less than 30%.

3. The hot stamped part according to claim 1, wherein the transition potion is formed to have the ferrite, bainite, and martensite structures.

4. The hot stamped part according to claim 1, wherein the iron-based alloy comprises 0.19-0.25 wt % of C, 0.40 wt % or less of Si, 1.10-1.60 wt % of Mn, 0.030 wt % or less of P, 0.015 wt % or less of S, 0.10-0.60 wt % of Cr, 0.0008-0.0050 wt % of B, the balance of Fe, and inevitable impurities.

5. The hot stamped part according to claim 1, wherein a tensile strength of the hot stamped part is equal to or greater than 1300 MPa.

6. The hot stamped part according to claim 1, wherein a bending angle of the hot stamped part is equal to or greater than 90°.

7. The hot stamped part according to claim 1, wherein a plating layer formed of an Al—Si-based alloy or a Zn-based alloy is further formed on each of surfaces of the reinforced portion and the softened portion.

8. A method for manufacturing a hot stamped part, the method comprising:
preparing a plate-type base metal using an iron-based alloy;
heating the prepared base metal;
forming a product by inserting the heated base metal between a first die and a second die and then pressing the base metal; and
cooling the product formed between the first die and the second die while differently maintaining a cooling speed of one surface of the product configured to come into contact with the first die and a cooling speed of a remaining surface of the product configured to come into contact with the second die.

9. The method according to claim 8, wherein:
in the forming the product, the first die is a heated die and the second die is a cooled die; and
the heated base metal is placed on the first die.

10. The method according to claim 9, wherein:
in the forming the product, a cavity having a recessed shape is formed in the first die, a protrusion having a projecting shape is formed on the second die so as to be inserted into the cavity, and a heated heating pad is disposed in the cavity of the first die; and
in the forming the product, when the heated base metal is placed on the first die, the heated base metal is placed on an upper surface of the first die and an upper surface of the heating pad.

11. The method according to claim 10, wherein:
in the forming the product, while the second die comes close to the first die and thus presses the heated base metal placed on the first die, the heating pad disposed in the cavity of the first die is inserted into the first die by pressing force of the second die, and thus, a space configured such that the heated base metal is formed into the product is secured.

12. The method according to claim 9, wherein, in the cooling the product, a softened portion configured to have ferrite and bainite structures is formed from the surface of the product configured to come into contact with the first die, and a reinforced portion configured to have a martensite structure is formed from the remaining surface of the product configured to come into contact with the second die.

13. The method according to claim 12, wherein, in the cooling the product, the softened portion is formed such that a ratio of a thickness of the softened portion to a total thickness of the product is equal to or less than 30%.

14. The method according to claim 12, wherein, in the cooling the product, the cooling speed of the surface of the product configured to come into contact with the first die is 3-5° C./s in a temperature section of 850-500° C., and the cooling speed of the remaining surface of the product configured to come into contact with the second die is equal to or higher than 27° C./s in a temperature section of 850-250° C.

15. The method according to claim 9, wherein, in the forming the product, the first die is heated to a temperature range of 300-450° C.
